(19) United States
(12) Patent Application Publication
(10) Pub. No.: US 2026/0200795 A1
(43) Pub. Date: Jul. 16, 2026

(54) BUILDING MATERIAL OR BINDER AND PROCESS FOR ITS PREPARATION AND USE OF A FIBRE AND A SHALE ADDITIVE AS A COMPONENT OF A BUILDING MATERIAL OR BINDER

(71) Applicant: Tilman Fritsch, Bayerisch Gmain (DE)

(72) Inventor: Tilman Fritsch, Bayerisch Gmain (DE)

(21) Appl. No.: 18/865,646

(22) PCT Filed: May 15, 2023
(86) PCT No.: PCT/EP2023/062893

§ 371 Date: Nov. 13, 2024

(30) Foreign Application Priority Data
May 13, 2022 (DE) 10 2022 112 015.5

(51) Int. Cl. C04B 14/10; C04B 28/10; C04B 111/00

(52) U.S. Cl. CPC C04B 14/108; C04B 28/10; C04B 2111/00637

(57) ABSTRACT

According to the invention, a binder or a building material comprises at least one fiber and a shale additive.

### BACKGROUND OF THE INVENTION

The invention relates to a binder or a building material comprising at least one fibre and a shale additive. The invention further relates to a method for producing a building material or a binder and to the use of a fibre and a shale additive as a component of a building material or a binder.

Binding agents and building materials such as concrete are known from the prior art. However, the mechanical strength, resistance to harmful influences and environmental compatibility of such building materials and binders are often problematic, usually with regard to some of the components used in the prior art.

### SUMMARY OF THE INVENTION

The object of the present invention is to overcome the disadvantages of the prior art.

The characterizing parts of the independent claims lead to the solution of the objects. Advantageous embodiments are described in the dependent claims.

The binder as disclosed herein comprises at least one fibre and a shale additive.

The binder can be selected from the group cement, lime and pozzolans.

The building material can include at least one binder as claimed and consist of a shale additive and at least one fibre.

The building material can contain at least one aggregate.

The building material can be selected from the group consisting of concrete, mortar and plaster.

The building material can include the binder selected from the group consisting of cement, lime and pozzolana.

The building material or binder can include the fibre is selected from the group consisting of organic natural fibre, inorganic natural fibre, chemical fibre, regenerated fibre and wood fibre.

The building material or binder can include the shale additive is contained in the building material or binder in the form of grit, sand, crushed stone or flour.

The building material or binder can include the shale additive is predominantly or completely present in the form of unblown shale.

A process for the preparation of a building material or binder comprising the following steps:
addition of a fibre
addition of a shale additive.

A use of a fibre and a shale additive as a component of a building material or binder is also contemplated.

### DETAILED DESCRIPTION

According to the present invention relates to a binder comprising at least one fibre and a shale additive. In the context of the present invention, the at least one fibre preferably refers to a group, type or variety of fibres, and not, for example, a single spun fibre which is often only visible under a microscope, nor, for example, a single filament.

It may be intended to use one or more types, varieties or groups of fibres.

The binder may, for example, be cement or a cement-like mixture, lime or a pozzolan. The binder can therefore be selected from the group cement, lime and pozzolans. In the context of the present invention, pozzolans are preferably understood to mean artificial or natural rocks which contain, for example, silicon dioxide, alumina, limestone, iron oxide or alkaline substances, and are preferably capable of binding in combination with calcium hydroxide and water.

According to the present invention relates to a building material comprising at least one binder and a shale additive as well as at least one fibre.

The building material can be selected from a group comprising concrete, mortar and plaster.

The binder contained in the building material may be selected from the group consisting of cement, lime and pozzolana. With regard to the binder, the above remarks on the binder according to an example of the present invention apply.

For example, concrete containing cement as a binder may be considered. Concrete containing lime and/or other pozzolans as a binder may also be intended.

Mortar containing cement as a binder may also be intended. Furthermore, mortar containing lime and/or other pozzolans as a binder may be envisaged.

The same applies to the building material plaster.

In addition to the binder, the shale additive and the fibre, the building material may contain an aggregate. Alternatively, the shale additive can be used as an additive and be the only such additive contained in the building material.

If the building material contains an additive in addition to the shale additive, this may be a filler, for example an aggregate.

The building material according to one example and the binder according to another example can contain at least one fibre, i.e. a type, group or variety of fibres, which can be selected from the group of organic natural fibres, inorganic natural fibres, chemical fibres, regenerated fibres and wood fibres. Organic natural fibres can be of animal or vegetable origin.

Organic natural fibres of animal origin can be, for example, wool, fine animal hair, coarse animal hair or silk. Examples of wool include sheep's wool, angora, cashmere and the like. Coarse animal hairs include, for example, horsehair or pig bristles. Silks that can be considered include mulberry silk or spider silk.

Organic natural fibres of plant origin can be seed fibres, bast fibres and hard fibres, for example. Examples of seed fibres include cotton or plant silk. Bamboo fibres, hemp fibres, nettle fibres and linen, i.e. flax fibres, can be considered as bast fibres. Fibres made from reed, straw or hay can also be considered. According to an example of the present inventions, plant fibres, i.e. organic natural fibres of plant origin, are particularly preferred.

Particularly preferred plant fibres are hemp fibres, linen and nettle fibres. The fibre can therefore be particularly preferably selected from the group hemp fibres, linen and stinging nettle fibres.

The aforementioned fibres, which are added to the binder or building material, increase its strength, durability and load-bearing capacity in a similar way to the addition of steel fibres. However, the aforementioned fibres, in particular the organic natural fibres and especially the plant fibres, are significantly more environmentally friendly and less expensive to manufacture and dispose of than steel fibres.

The building material or the binder can contain the shale additive in the form of grit, sand, crushed stone or flour in the building material or binder.

In the context of the present invention, shale in the form of grit, which is added to the building material or binder as an additive, is preferably understood to be a bulk material consisting of stones with diameters of between 2 and 63 millimeters (mm). In contrast to gravel, which consists of round pebbles, chippings usually consist of rather sharp-edged broken stones.

Shale can also be used as an additive in the form of sand, crushed stone or flour. In the context of the present invention, sand preferably means a bulk material made of rock with a grain size of 0.063 mm to 2 mm. Crushed stone preferably means rock with a grain size of between 32 and 63 mm. Flour preferably means rock with a grain size of less than 0.063 mm.

The shale additive can be predominantly or completely in the form of unblown shale. Expanded shale is a porous and therefore lightweight aggregate which is produced industrially in an expansion process taking place at approximately 1,200° C.

In the context of the present invention, a shale additive present predominantly in the form of unblown shale means shale in the form of a bulk material which preferably consists of more than 50%, more preferably more than 70% and even more preferably more than 90% unblown shale. A shale additive present entirely in the form of unblown shale means a bulk material which contains no blown shale.

A shale additive that consists predominantly or entirely of unblown shale has proven to be advantageous. The non-expanded shale in particular has a reducing effect, i.e. acts as an electron donor. This can have a positive effect on the setting process of concrete, for example, in which chemical processes such as hydration are positively influenced at the interface between cement and water.

The shale additive, especially the non-expanded part of the shale, also has a positive effect after the building material has set. For example, the building material, e.g. the concrete, is more water-repellent, more acid-resistant, more frost-resistant, less reactive with regard to nitrogen compounds, mechanically more stable, less prone to mould formation and germination as well as to sulphur formation during ageing than would be the case without the shale additive. The shale additive also improves the surface density. The reducing property of the shale additive, which can also be retained after setting, also results in an anti-oxidative property of the component made from the building material, for example a concrete wall or the like. On the one hand, this results, for example, in the reduced tendency to microbial contamination described above. On the other hand, this anti-oxidative, i.e. reducing property of the shale additive also has a positive effect if the component in question is reinforced concrete, as the steel is more resistant to corrosion thanks to the shale additive.

Furthermore, the reducing property of the shale additive, especially if it is sand, flour or grit made from unblown shale, has the effect of advantageously preserving the added fibres, for example organic natural fibres such as plant fibres. Furthermore, the shale additive protects the aforementioned fibres from moisture. In addition to the aforementioned advantages of the shale additive, it also preserves the fibres so that the durability of a component made from the binder or building material is extended and the advantageous properties of the fibres are retained for longer, even under adverse conditions.

Bacteria can optionally be applied to the fibre before it is added to the binder or building material.

This can refer to bacteria that are capable of biomineralization. In general, therefore, mineral-forming bacteria, in particular calcifying bacteria, can be considered. For example, bacteria of the species Sporosarcina pasteurii, the species Bacillus cohnii or the species Bacillus pseudofirmus can be used.

The purpose of applying the bacteria to the fibres can be, on the one hand, to provide the bacteria with a suitable carrier with which they can be introduced into the building material or binder as a component of the building material or binder. On the other hand, the fibres can serve as a starting material for metabolic processes of the bacteria. On the one hand, the bacteria can feed on the fibres or reproduce with the help of the fibres and on the fibres. On the other hand, the fibres can provide starting materials for such metabolic processes of the bacteria which are to be understood as biomineralization, i.e. in which mineral products are formed.

These mineral products, for example phosphates or carbonates, can be formed by the bacteria from corresponding sources, i.e. starting materials containing a phosphorus or calcium source. These mineral products can fill and thus repair cracks or defects that form, for example, during or after the setting of concrete, i.e. during or after its drying and hardening. It is also possible that at least some of the bacteria in the building material, for example in the concrete, survive or are at least preserved to such an extent that at least the metabolic processes that enable biomineralization are maintained for a long time, i.e. for years and even decades. The bacteria can remain dormant and inactive for years and even decades. If cracks or similar defects occur in the building material, for example in the concrete, the bacteria can become active and carry out the desired biomineralization by means of corresponding metabolic processes. For example, bacteria of the species Sporosarcina pasteurii, the species Bacillus cohnii and the species Bacillus pseudofirmus are able to remain dormant and inactive for decades and only become active after contact with air and moisture, i.e. when cracks or defects occur in the building material, for example in the concrete. The fibres to which the bacteria have been applied serve as carriers and suppliers for the bacteria.

Building materials such as concrete, into which bacteria with the aforementioned ability to repair any cracks that may occur have been introduced, are sometimes referred to as self-healing building materials, e.g. self-healing concrete.

The fibres used according to the invention, in particular plant fibres, are inexpensive, easy to handle and it is possible to apply the bacteria and to introduce the fibres mixed with bacteria into the binder or into the building material simply and inexpensively.

If cracks or the like form in a component made of the building material, for example a concrete component, due to prolonged or intensive exposure to harmful influences such as frost, chemicals, acids, oxidative agents or mechanical stress, the shale additive can provide an alkaline environment which is preferred by some of the bacteria capable of biomineralization.

According to of the present invention, the building material, for example concrete, mortar or plaster, may comprise the following components: An organic natural fibre, which is preferably selected from the group consisting of hemp fibres, linen and nettle fibres; a binder, which is selected from the group consisting of cement, lime and pozzolana; a shale additive in the form of grit, sand, crushed stone or flour, which is predominantly or entirely in the form of unblown shale; at least one aggregate. According to this embodiment, the building material contains no steel, no steel fibres, no bactericides, no toxic additives such as setting accelerators or water repellents.

In addition to the above-described binder and the above-described building material, the present invention further comprises, according to an embodiment example, a method for producing a building material or a binder comprising the following steps:
addition of a fibre
addition of a shale additive.

With regard to details of the binder, the building material, the fibres and the shale additive with regard to the aforementioned process, reference is made to the explanations of the building material and the binder according to the embodiments described above.

As described above with regard to the building material and the binder, bacteria can also be applied to the fibre according to the present method. The bacteria are preferably applied to the fibre before the fibre is mixed with other components of the building material or the binder.

If bacteria are to be used, the fibre can, for example, be suspended in a bacterial suspension, mixed with it, sprayed, soaked in it or sprinkled with it. Other variants for applying the bacteria to the fibre are conceivable.

It may also be possible to incubate the fibre before adding it to the building material or binder in order to multiply the bacteria. The fibre can therefore be inoculated with the bacteria. Incubation can take place over several hours or days. An evolutionary selection process of the bacteria can take place before they are added to the building material or binder, so that after the building material, for example the concrete, has hardened and dried, a large number of those bacteria are present on the fibres which feel most comfortable on the selected fibres with regard to their properties as carriers and suppliers of starting materials for bacterial metabolism.

A building material or binder produced in this way is particularly durable and therefore particularly sustainable. The longevity alone increases the sustainability of the building material or binder enormously. Furthermore, the use of fibres, in particular when plant fibres or other fibres of natural origin are used, makes it possible to dispense with toxic, environmentally harmful and, for example, poorly degradable additives, which in the prior art provided the increase in resilience that can be provided by the fibres according to the invention.

Of course, only one type or even several types of bacteria can optionally be used for the building material according to the invention, the binder according to the invention and the method according to the invention.

The present invention further comprises the use of a fibre and a shale additive as a component of a building material or binder. Here, the fibre and the shale additive are used in combination. For details of the building materials or binders, the fibre and the shale additive, reference is made to the binders and building materials described above in accordance with the described embodiments.

1. Binder comprising at least one fibre and a shale additive.

2. Binder according to claim 1, which is selected from the group consisting of cement, lime and pozzolans.

3. Building material comprising at least one binder described in claim 1, consisting of a shale additive and at least one fibre.

4. Building material according to claim 3, containing at least one aggregate.

5. Building material according to claim 3, which is selected from the group consisting of concrete, mortar and plaster.

6. Building material according to claim 3, wherein the binder is selected from the group consisting of cement, lime and pozzolana.

7. Binder according to claim 1, wherein the fibre is selected from the group consisting of organic natural fibre, inorganic natural fibre, chemical fibre, regenerated fibre and wood fibre.

8. Binder according to claim 1, wherein the shale additive is contained in the building material or binder in the form of grit, sand, crushed stone or flour.

9. Binder according to claim 1, wherein the shale additive is predominantly or completely present in the form of unblown shale.

10. Process for the preparation of a building material or binder comprising the following steps:
addition of a fibre
addition of a shale additive.

11. Use of a fibre and a shale additive as a component of a building material or binder.

12. Building material according to claim 3, wherein the fibre is selected from the group consisting of organic natural fibre, inorganic natural fibre, chemical fibre, regenerated fibre and wood fibre.

13. Building material according to claim 3, wherein the shale additive is contained in the building material or binder in the form of grit, sand, crushed stone or flour.

14. Building material according to claim 3, wherein the shale additive is predominantly or completely present in the form of unblown shale.
